(19) United States
(12) Patent Application Publication
(10) Pub. No.: US 2009/0140922 A1
(43) Pub. Date: Jun. 4, 2009

(54) BISTATIC RADIOFREQUENCY DEVICE FOR PRODUCING AN INTRUSION DETECTING BARRIER

(75) Inventor: Jean-Jacques Maintoux, Velizy (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 11/995,094

(22) PCT Filed: Jul. 3, 2006
(86) PCT No.: PCT/EP2006/063791

§ 371 Date: Jul. 14, 2008

(51) Int. Cl. G01S 13/00

(52) U.S. Cl. 342/379

(57) ABSTRACT

The present invention relates to the field of protecting geographic areas against undesirable, even hostile, intrusions from threatening moving objects. The subject of the invention is a bistatic radiofrequency detection barrier having means for transmitting one or more waves through a directional antenna and means for receiving signals through a directional antenna pointing in the transmission direction. This antenna includes auxiliary means for transmitting a wave through a non-directional antenna and means for comparing the relative levels of the echos received from the wave transmitted by the main, directional transmission channel, and the echos originating from the wave transmitted by the auxiliary transmission channel. The result of the comparison makes it possible to identify the echos deriving from a wave transmitted in the direction of the side lobes of the directional transmission antenna, and so reduce the number of false intrusion alarms. The invention relates more particularly to the protection of areas where vulnerable equipment is implemented and being trialed, the destruction of which may prove hazardous to nearby populations.

### CROSS-REFERENCE TO RELATED APPLICATIONS

The present Application is based on International Application No. PCT/EP2006/063791, filed on Jul. 3, 2006 and priority is hereby claimed under 35 USC §119 based on this application. This application is hereby incorporated by reference in its entirety into the present application.

### FIELD OF THE INVENTION

The present invention relates to the field of the protection of geographic areas against undesirable, even hostile, intrusions from moving objects likely to endanger installations or persons located in these zones. It more particularly relates to the protection of areas where vulnerable equipment is implemented and being trialed, the destruction of which may prove hazardous to nearby populations.

### BACKGROUND OF THE INVENTION

To protect a determined space or geographic area, it is known that a safety perimeter protected by barriers implemented in various ways should be formed. The particular function of these barriers is to detect intrusions through them by undesirable parties. Among these barriers, it is possible to distinguish those that have a physical structure, such as fences or other enclosing walls, and those that have an intangible structure such as, for example, acoustic or electromagnetic barriers, the function of this second type of barrier being to detect intrusions in as safe and discreet a way as possible. It is also possible to protect a space by using electromagnetic detection means, of radar type for example, which cover all of the space to be protected.

Radar protection has the advantage of allowing a wide coverage that can include an intrusion detection area located outside the area to be protected. On the other hand, because of its operating principle and the frequencies involved, the protection offered by a radar has limits linked in particular, according to the working frequency involved, to the nature of the terrain of the area to be protected, and to the possible presence of significant vegetation, such as trees for example. This is why radar protection proves ineffective when the requirement is to provide intrusion detection at ground level or very low altitude. Now, this motion field which extends from the ground to an altitude less than a hundred meters in height for example is the motion field for certain aerial threats such as certain drones or ULM for example.

The use of barriers consisting of networks of infrared sensors or even barriers such as electrified fences has the advantage of making it possible to prevent a ground intrusion. On the other hand, it does not make it possible to prevent intrusion from objects flying at very low altitude. Also, this type of protection is intrinsically not very mobile and extremely vulnerable because of its visibility.

Another means of forming a protection barrier consists in using bistatic radiofrequency devices making it possible to construct detection barriers whose effectiveness extends from ground level to a sufficient altitude to cover the motion field of threats that cannot be detected by a radar. Such devices generally consist of a transmitter equipped with a directional antenna transmitting a signal to a receiver equipped with a directional antenna pointing in the direction of the transmitter. These devices can be used to produce relatively effective barriers with height, length and thickness dimensions that can be suited to the requirements by defining the corresponding radiation patterns. They also present the advantage of being easy to deploy and make it possible to rapidly put in place temporary mobile protection barriers around temporarily hazardous or vulnerable sites. Nevertheless, the drawback of these barriers is the number of false detections that lead to false intrusion alarms. These false alarms are mainly due to the presence of side lobes on the radiation patterns of the transmission and reception antennas. These side lobes are in particular responsible for the detection of non-intrusive objects that are seen as passing through the barrier.

### SUMMARY OF THE INVENTION

One aim of the invention is to increase the detection quality of the bistatic radiofrequency barriers in order to reduce the number of false intrusion alarms while retaining the qualities associated with this type of barrier.

To this end, the subject of the invention is a bistatic radiofrequency detection barrier comprising means for transmitting one or more waves through a directional antenna and means for receiving signals through a directional antenna pointing in the transmission direction. This antenna is characterized in that it also comprises means for transmitting a wave through a non-directional antenna and means for comparing the relative levels of the echos received from the wave transmitted by the directional transmission antenna and the echos originating from the wave transmitted by the non-directional transmission antenna, the result of the comparison making it possible to identify the echos deriving from a wave transmitted in the direction of the side lobes of the directional transmission antenna.

In a preferred embodiment, the transmitted waves are CW waves.

According to a variant of embodiment, the device according to the invention also comprises means for eliminating the echos received by the reception means through the side lobes of the directional reception antenna.

In a preferred embodiment, the gain of the non-directional transmission antenna in the direction pointed to by the side lobes of the directional transmission antenna is between the gain of the directional transmission antenna in the direction of the side lobes and the gain of this same antenna in the direction of the main lobe.

According to a variant of embodiment, the means for transmitting the directional wave and the means for transmitting the non-directional wave are synchronized by a periodic signal so as to alternately transmit a directional wave and a non-directional wave.

According to a variant of embodiment, the alternate transmission of a directional wave and of a non-directional wave is implemented when an intrusion is detected, the transmission of a directional wave being permanent in the absence of detection.

According to a variant of embodiment, the means for transmitting the directional wave and the means for transmitting the non-directional wave simultaneously transmit waves of different frequencies.

In a preferred embodiment, the frequency of the CW directional wave transmitted can vary over time.

In another preferred embodiment, the means for transmitting at least one directional wave simultaneously transmit two CW waves of different frequencies.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### DESCRIPTION OF THE FIGURES

The present invention is illustrated by way of example, and not by limitation, in the figures of the accompanying drawings, wherein elements having the same reference numeral designations represent like elements throughout and wherein:

FIG. 1, an illustration of the problem posed by the use of bistatic barriers according to the known prior art,

FIG. 2, the diagrammatic illustration of the operating principle of a bistatic radiofrequency barrier according to the invention,

FIG. 3, the representation in one and the same diagram of the curves of gain variation versus azimuth of the directional and non-directional antennas according to the invention,

FIG. 4, the diagrammatic illustration of one embodiment of the means of transmitting a barrier according to the invention, taken as a nonlimiting example,

FIG. 5 the diagrammatic illustration of a second embodiment of the means of transmitting a barrier according to the invention,

FIG. 6, the illustration of the principle of implementing barriers according to the invention to protect an area delimited by a fixed perimeter.

### DETAILED DESCRIPTION

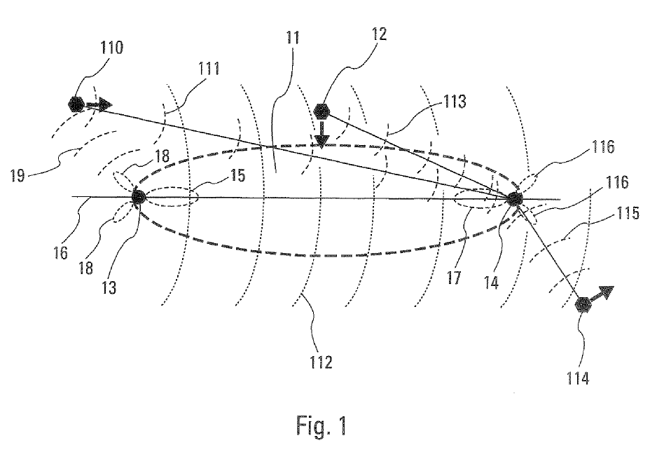

Refer first to FIG. 1, this simply reveals the problem raised by the existing bistatic barriers. As illustrated by FIG. 1, such a barrier is intended to form a perimetric detection area 11 surrounding the geographic area for which access is to be controlled. Its main function is to detect the ingress of objects 12 into the detection area 11 and then, if necessary, to detail the motion parameters of the detected object, the aim being to trigger an alarm in the event of the illicit ingress of an object into this area, and this with the best possible reliability.

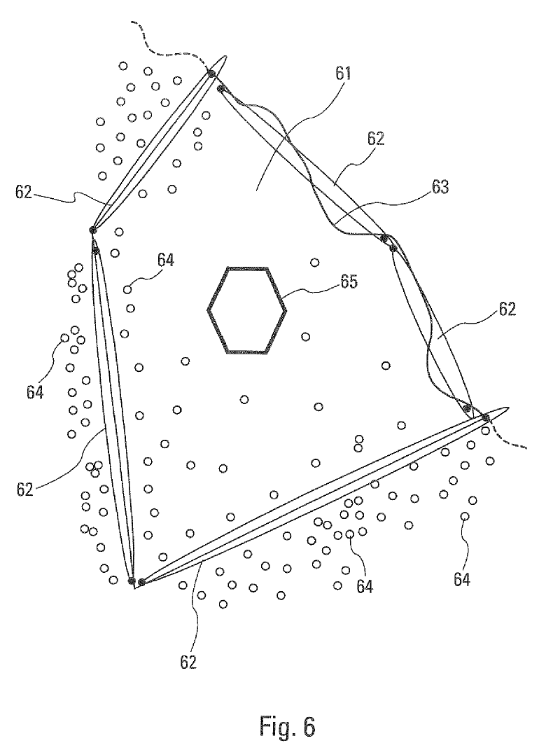

A sensitive geographic area 61 around a building 65, bordering on a coastline 63 and backing onto an area planted with trees 64 for example, can in this way be protected against intrusions. For this, all that is needed, as illustrated in FIG. 6, is to locate a set of barriers 62 along the perimeter which defines the area to be protected.

Creating such a barrier mainly entails using transmission and reception means 13 and 14. The main characteristic of the transmission means 13 is to be equipped with a directional antenna, for which the main lobe 15 of the radiation pattern makes it possible to cover as selectively as possible the field of the space that forms the detection area 11. The reception means 14 also comprise a directional antenna, the radiation pattern 17 of which points to the transmission means in the direction 16 that coincides with the axis of the barrier.

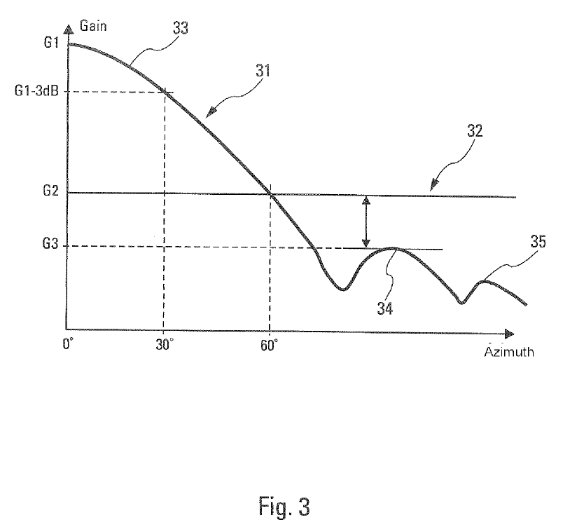

Such a barrier has the advantage of being inexpensive in terms of implementation means. The shape and the length of the barrier depend in particular on the radiation patterns of the antennas used and the power characteristics of the transmitter 13 and the situation of the transmitter 13 and of the receiver 14. Thus, to obtain a sufficiently long barrier, it is, for example, possible to place the transmitter and the receiver at the top of masts or towers, as illustrated in FIG. 3.

Inasmuch as the detection barrier is intended to cover an area of the space extending from the ground to a low altitude, this area possibly including relief and vegetation elements, such as trees, for example, the transmission frequency of the transmitter forming such a barrier is normally located in the VHF or UHF range.

Depending on the positioning of the transmitter 13 and of the receiver 14, the relative distance that separates them, and the transmission power, it is thus possible to produce a bistatic radiofrequency barrier of long length, 10 to 20 kilometers for example, by transmitting a wave of relatively low power, of the order of a few tens of watts.

Although they offer the abovementioned advantages, the current bistatic barriers nevertheless present the major drawback of being subject to a relatively high false intrusion alarm rate. As illustrated in FIG. 1, this false alarm rate is mainly caused by the presence of side lobes in the radiation patterns of the directional antennas of the transmission means 13 and of the reception means 14.

Regarding the antenna of the transmission means 13, the main source of false alarms lies in the radiation of part of the wave transmitted through the side lobes 18 of the antenna. This radiation is by nature directed in a direction different from the axis pointed to by the main lobe and can be reflected by objects located well outside the area of the barrier.

This part 19 of the transmitted wave can therefore be reflected to the receiver 14 by an object 110 moving outside the area to be protected. The duly reflected wave 111 is detected on the receiver 14 in the same way as the wave 113 deriving from the wave 112 transmitted by the main lobe and reflected by an object 12 trying to pass through the barrier. Because of the reflected wave 111, the object 110 may unjustly be detected as an object trying to pass through the barrier and be the cause of a false alarm.

Regarding the antenna of the reception means 14, the main source of false alarms lies in the reception of the waves 115 reflected by any object 114 located behind the reception means 14 and deriving from the wave 112 transmitted by the main lobe. These reflected waves, although they originate from an object 114 moving outside the area to be protected, without trying to pass through the barrier, are picked up by the side lobes 116 of the reception antenna. In this way, like the objects 110 subject to the transmissions deriving from the side lobes of the transmission antenna, the object 114 will be unjustly detected as an object trying to pass through the barrier and will be the cause of a false alarm.

The detection function provided by a conventional radiofrequency barrier is thus subject to two types of disturbances:
a disturbance linked to a pollution of the reception means by the signals deriving from the parts of the wave transmitted through the side lobes 18 of the transmission antenna,
a disturbance linked to a pollution of the reception means by the signals deriving from the waves received by the side lobes 116 of the reception antenna.

These two types of pollution with different origins are the main causes of false intrusion alarms.

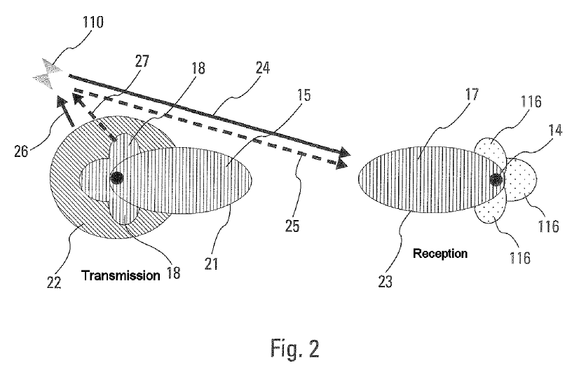

Refer now to FIG. 2. This figure simply illustrates the technical characteristics of the bistatic barrier according to the invention.

To be able to resolve the problem posed by the presence of side lobes in the radiation patterns of the transmission and reception antennas, the bistatic barrier according to the invention has main transmission means 13 that can transmit the wave 112 which constitutes the barrier. In a known way, these means comprise an antenna, the pattern 21 of which is directional, the main lobe of this pattern being directed toward the reception means 14.

The bistatic barrier according to the invention also comprises auxiliary transmission means that can transmit a wave non-directionally. These second means comprise an antenna provided with a non-directional radiation pattern 22, omnidirectional for example.

Depending on the chosen embodiment, these two transmission means can, for example, be totally separate. They can also be produced from a single transmitter provided with two antennas, one directional and the other non-directional, and switching means enabling it to transmit on one or other of the antennas.

The bistatic barrier according to the invention also comprises reception means 14 provided with an antenna having a directional radiation pattern, the main lobe 23 of which is oriented roughly in the direction of the main lobe 21 of the directional transmission antenna.

According to the invention, the problem posed by the presence of side lobes on the radiation pattern of the directional transmission antenna can be resolved advantageously through auxiliary transmission means. To do this for any signal received by the reception antenna in a given direction, the reception means compare the levels of the signal deriving from the directional transmission and the level of the signal deriving from the non-directional transmission. Depending on the mode of operation of the transmission means, these two signals are received simultaneously or one after the other. Depending on the result of the comparison, the signal originating from the main transmission, via the directional antenna, is considered to derive from a transmission through the main lobe oriented in the direction to be protected, or from the transmission through a side lobe oriented in a direction that is of no interest in protection terms.

In practice, the comparison relates to the relative levels of the received signals.

Refer now to FIG. 3, which illustrates the way in which, for example, the respective gains of the directional and non-directional transmission antennas can be defined, in the context of the invention.

FIG. 3 represents, on one and the same graph, as a function of the azimuth, the curve gain 31 of the directional antenna and the curve gain 32 of the non-directional antenna. The 0° azimuth here represents the direction in which the main lobe of the directional antenna 32 points.

The main, directional, antenna is defined conventionally by the width of its main lobe 33, at −3 dB of the maximum gain G₁, and by the presence of side lobes 34 and 35. The omnidirectional auxiliary antenna is characterized by a gain curve of constant value G₂. The two gain curves are defined so that the gain G₂ of the omnidirectional antenna is less than the gain G₁-3 dB which corresponds to the minimum gain of the antenna in the space covered by the main lobe 33, and greater than the gain of the directional antenna in the direction of the side lobes 34 and 35.

Thus, if the signal level originating from the directional main transmission is greater than the signal level originating from the non-directional auxiliary transmission, the signal detected is considered to correspond to an object 12 having penetrated through the barrier. Conversely, if the signal level originating from the directional main transmission is less than the signal level originating from the non-directional auxiliary transmission, the detected signal is considered as a spurious signal corresponding to a non-threatening object 110 moving outside the barrier.

FIG. 2 illustrates the particular case of a non-threatening object 110 reflecting waves 24 and 25 deriving from the omnidirectional wave 26 and from the directional wave 27 transmitted by a side lobe 18. This particular echo case causing a false intrusion alarm in the existing bistatic barriers is handled by the reception means 14 of the barrier according to the invention by comparing the relative levels of the waves 24 and 25. In this example, the level of the main wave 25 reflected by the object 110 is greater, because of the respective gains of the transmission antennas, than the level of the auxiliary reflected wave. The detected echo will therefore be identified as a spurious echo not to be taken into account.

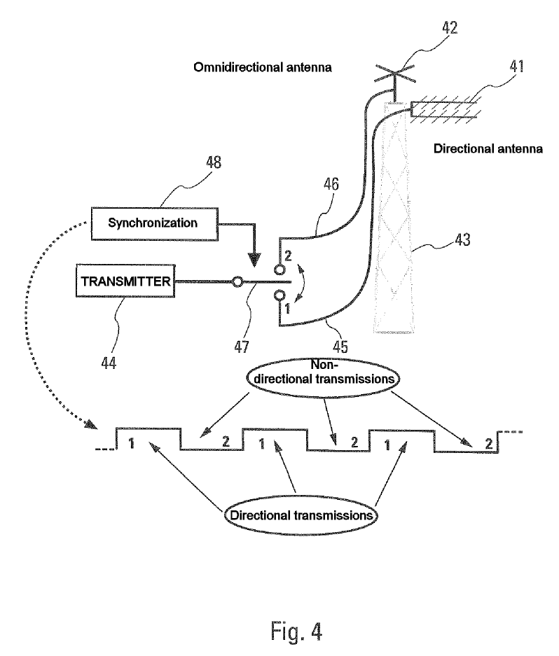

Refer now to FIG. 4. This figure illustrates a particular embodiment of the barrier according to the invention. FIG. 4 represents only the structure of the transmission means, the reception means being constructed in a similar way. In this embodiment, taken as a non-limiting example, the transmission means comprise a directional antenna 41 and a non-directional antenna 42 mounted on a pylon 43. These two antennas are connected to a single transmitter 44 via cables 45 and 46 and controllable switching means 47. The transmitter produces, for example, a CW UHF wave.

The switching of the CW wave to one or other of the antennas is handled by synchronization means which define the chosen sequencing for transmitting on one or other of the antennas. In the example illustrated by FIG. 4, the CW wave is transmitted alternately on one of the antennas then on the other. The switching period is chosen so that the signals received by each of the antennas can be compared even in the case where the object originating these signals is moving.

The signals deriving from the transmitted CW wave are picked up by a directional reception antenna not represented in the figure. This reception antenna is similar to the directional transmission antenna 41. It is also mounted on a pylon and is oriented toward the directional transmission antenna 41.

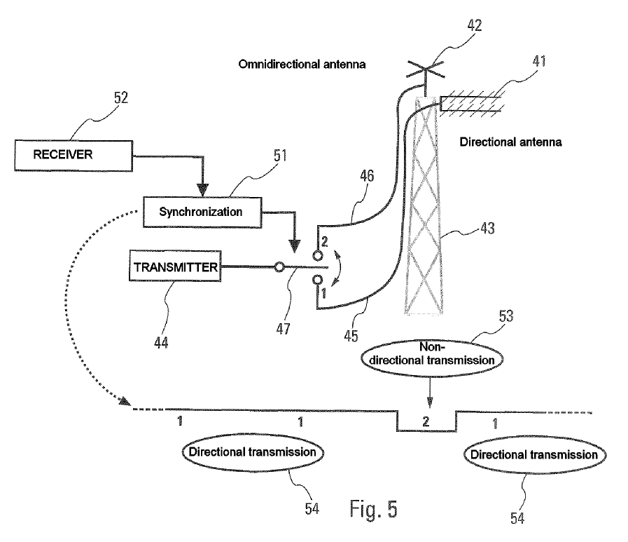

This first embodiment presents the advantage of using a simple, periodic sequencing and being able to operate autonomously independently of the processing applied to the received signals. The transmission means thus operate automatically. On the other hand, since the wave is transmitted periodically by the omnidirectional antenna, the presence of the barrier is more easy to detect. This is why another implementation of the transmission means may be preferred, such as, for example, that described in FIG. 5.

The transmission means implemented in the embodiment of FIG. 5 comprise, like those of FIG. 4, a directional antenna 41 and a non-directional antenna 42, omnidirectional for example, both mounted on a pylon 43 and linked to a transmitter 44 through a switch 47 by cables 45 and 46. However, in this embodiment, the switch 47 is operated by synchronization means 51 which receive information from the reception means forming the barrier, from the receiver 52 for example. In this particular embodiment, the synchronization means operate the switch 47 asynchronously, when a risk of false intrusion alarm exists. The non-directional auxiliary transmission 53 can thus be controlled when the reception means have detected a signal originating from an object likely to attempt an intrusion beyond the barrier. Since all the rest of the time is occupied by the main directional transmission 54, this embodiment, although somewhat more complex, provides a more discreet operation rendering the presence of the barrier less detectable.

The two particular embodiments illustrated by FIGS. 4 and 5 are of course not limiting, any solution making it possible to differentiate the signals originating from the main transmission from those originating from the auxiliary transmission being able to be used. It is, in particular, possible to make this distinction by differentiating between the main and auxiliary waves not by the transmission instant but by the frequency. It is possible, for example, to simultaneously transmit, using two transmitters, or sequentially transmit, using one transmitter with frequency switching, a main CW wave of frequency F₁ and an auxiliary CW wave of frequency F₂.

The use of transmission means comprising two antennas, a directional main antenna and a non-directional auxiliary antenna, each antenna having a gain defined in the various directions of the space, makes it possible advantageously to limit the risk of false intrusion alarms as a result of the transmission of a wave through the side lobes of the main transmission antenna. This advantageous characteristic is complemented according to the invention by the integration in the reception means of means capable of detecting and eliminating the signals received by the reception antenna through its side lobes. These means apply known methods, not expanded here, of processing the received signals, conventionally used in particular in radars for neutralizing the scrambling actions of radars by secondary antenna lobes. These methods include the SLS (side-lobe suppression) or SLO (side-lobe opposition) type methods. These means of suppressing signals received by the reception antenna through its side lobes then advantageously complement the means of suppressing signals deriving from the wave transmitted by the side lobes of the transmission antenna. The cooperation of these two means thus makes it possible to resolve overall the problem of false intrusion alarms posed by the use of bistatic radiofrequency barriers.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalent thereof.

1-9. (canceled)

10. A bistatic radiofrequency detection barrier, comprising:
means for transmitting at least one wave through a directional antenna and
means for receiving signals through a directional antenna pointing in the transmission direction,
means for transmitting a wave through a non-directional antenna and means for comparing the relative levels of the echos received from the wave transmitted by the directional transmission antenna and the echos originating from the wave transmitted by the non-directional transmission antenna, the result of the comparison for identifying the echos deriving from a wave transmitted in the direction of the side lobes of the directional transmission antenna.

11. The device as claimed in claim 10, in which the transmitted waves are CW waves.

12. The device as claimed in claim 10, further comprising means for eliminating the echos received by the reception means through the side lobes of the directional reception antenna.

13. The device as claimed in claim 10, in which the gain of the non-directional transmission antenna in the direction pointed to by the side lobes of the directional transmission antenna is between the gain of the directional transmission antenna in the direction of the side lobes and the gain of this same antenna in the direction of the main lobe.

14. The device as claimed in claim 10, in which the means for transmitting the directional wave and the means for transmitting the non-directional wave are synchronized by a periodic signal so as to alternately transmit a directional wave and a non-directional wave.

15. The device as claimed in claim 14, in which the alternate transmission of a directional wave and of a non-directional wave is implemented when an intrusion is detected, the transmission of a directional wave being permanent in the absence of detection.

16. The device as claimed in claim 10, in which the means for transmitting the directional wave and the means for transmitting the non-directional wave simultaneously transmit waves of different frequencies.

17. The device as claimed in claim 11, in which the frequency of the CW directional wave transmitted can vary over time.

18. The device as claimed in claim 11, in which the means for transmitting at least one directional wave simultaneously transmit two CW waves of different frequencies.

19. The device as claimed in claim 11, further comprising means for eliminating the echos received by the reception means through the side lobes of the directional reception antenna.

20. The device as claimed in claim 11, in which the gain of the non-directional transmission antenna in the direction pointed to by the side lobes of the directional transmission antenna is between the gain of the directional transmission antenna in the direction of the side lobes and the gain of this same antenna in the direction of the main lobe.

21. The device as claimed in claim 11, in which the means for transmitting the directional wave and the means for transmitting the non-directional wave are synchronized by a periodic signal so as to alternately transmit a directional wave and a non-directional wave.

22. The device as claimed in claim 13, in which the means for transmitting the directional wave and the means for transmitting the non-directional wave are synchronized by a periodic signal so as to alternately transmit a directional wave and a non-directional wave.

23. The device as claimed in claim 11, in which the means for transmitting the directional wave and the means for transmitting the non-directional wave simultaneously transmit waves of different frequencies.

24. The device as claimed in claim 13, in which the means for transmitting the directional wave and the means for transmitting the non-directional wave simultaneously transmit waves of different frequencies.

25. The device as claimed in claim 13, in which the frequency of the CW directional wave transmitted can vary over time.

26. The device as claimed in claim 16, in which the frequency of the CW directional wave transmitted can vary over time.

27. The device as claimed in claim 13, in which the means for transmitting at least one directional wave simultaneously transmit two CW waves of different frequencies.

28. The device as claimed in claim 16, in which the means for transmitting at least one directional wave simultaneously transmit two CW waves of different frequencies.
